(19) United States
(12) Patent Application Publication
(10) Pub. No.: US 2009/0285937 A1
(43) Pub. Date: Nov. 19, 2009

(54) COMBINATION WATER AND FOOD INSECT SUPPLEMENT

(75) Inventors: Gordon J. Vadis, Ham Lake, MN (US); Allen Cohen, Raleigh, NC (US)

Correspondence Address: NIKOLAI & MERSEREAU, P.A., 900 SECOND AVENUE SOUTH, SUITE 820, MINNEAPOLIS, MN, 55402, US

(73) Assignee: THE BUG COMPANY OF MINNESOTA, Ham Lake, MN (US)

(21) Appl. No.: 12/466,869

(22) Filed: May 15, 2009

Related U.S. Application Data
(60) Provisional application No. 61/053,486, filed on May 15, 2008.

(51) Int. Cl. A23L 1/28; A23L 1/05

(52) U.S. Cl. 426/62; 426/573

(57) ABSTRACT

In some embodiments, an insect food supplement may include one or more of the following features: (a) a dry extruded food pellet, (b) a gelled water pellet, and (c) a water barrier on an external surface of the gelled water pellet.

### FIELD OF THE INVENTION

Embodiments of the present invention generally relate to insects. Particularly, embodiments of the present invention relate to feeder insects. More particularly, embodiments of the present invention relate to insect dietary supplements for use in feeding insects, which are, in turn, fed to animals of prey.

### BACKGROUND

The term ‘feeder insect’ includes insects commercially reared as food for captive zoo animals and certain other exotic household pets. Examples of feeder insects include waxworms, mealworms, locusts, superworms, silkworms, black soldier fly larvae and crickets. Crickets, order, Orthoptera: family Gryllidae (also known as “true crickets”), are insects somewhat related to grasshoppers (also members of the order Orthoptera) and more closely related (in the same sub-order, Ensifera) to katydids or bush crickets (family Tettigoniidae). They have somewhat flattened bodies and long antennae. There are about 900 species of crickets. They tend to be nocturnal and are often confused with grasshoppers because they have a similar body structure including jumping hind legs. Crickets are omnivores and scavengers feeding on organic materials, as well as decaying plant material, fungi, and some seedling plants. Crickets also have been known to eat their own dead when there is no other source of food available.

Crickets in nature generally mate in late summer and lay their eggs in the fall. The eggs hatch in the spring and have been estimated to number as high as 2,000 per fertile female. Female crickets have a long needlelike egg-laying organ (ovipositor). Certain cricket species are popular as a live food source for carnivorous zoo animals and pets like frogs, lizards, salamanders and spiders. Feeding crickets with nutritious food in order to pass the nutrition onto animals eating them is known as gut loading.

Captive insectivorous animals (including the mammalian orders of primates, insectivores, bats, and some carnivores, birds, many reptiles, amphibians, fish, and many invertebrates such as spiders and scorpions) suffer from malnutrition because the limited foods in their diets do not contain a good nutritional profile. In nature, these animals are free to forage for and select prey providing all their required nutrients. According to various sources captive animals are limited to the foods their holders find convenient to offer them, and these feeder insects are limited to a narrow range of species (e.g., crickets, mealworms, wax worms, etc.) Often pet owners, in attempts to provide dietary variety, feed their pets locally collected insects or other invertebrates, which may cause problems because of potential toxins, to which exotic pets are not adapted. The problems for institutions, which keep captive animals, are even more greatly dependent upon the nutritional value of commercially available pet foods.

In the wild, animals naturally satisfy themselves by selecting from a wide variety of foods. Most are opportunistic feeders and will eat a mixture of insects, smaller animals, and plant material. For instance, most aquatic and box turtles eat a little bit of nearly everything encountered within a reasonable size range. They consume lots of insects and worms as well as plant life. Others, like geckos and chameleons, mostly eat a wide variety of insects and other invertebrates such as spiders and snails. Though each species and age group tends to have preference for either more or less animal protein or vegetation in their diet, most readily accept insects as food. However, captive animals often suffer nutrient deficient diets because the well-fed insects they require for good health are missing from their captive diet.

In the wild, these natural food items have themselves fed on natural and nutritious diets providing a healthful and varied diet to those consuming them. Moreover, wild animals naturally seek out the kind of nutrition they need as their nature dictates. This is a well-documented process called “nutrient self-selection”.

In captivity, the variety of cultured insect prey is limited by limitations in rearing technology and these feeder insects often lack the vitality and nutritional variety of their wild counterparts. In turn, captive vertebrates and invertebrates are often fed diets lacking the natural variety keeping them healthy in the wild. As a result, animals are often lacking in nutrients they would otherwise have available to them and certain metabolic imbalances can and do occur. Poorly fed insects mean poorly fed pets.

Captive animals rely on their owner to provide the assortment of quality foods necessary to promote good health. It is recommended pet owners offer a wider range of cultured insects such as waxworms, mealworms, crickets, superworms and other organic matter properly prepared for their pets.

It is common knowledge in the pet industry feeder insects are not properly cared for by retail employees, pet owners and even zoo personnel. Insects should be ‘gut loaded’ (fed nutritious food passed on to the captive animal) for at least 24 continuous hours prior to offering them as food to captive animals. Retailers and insect consumers in general are busy people and often forget to care for insects. When they do care they are seldom properly trained or equipped to properly care for insects. Not many keepers remember to follow insect-feeding recommendations. As a result, many animals are fed insects themselves starved for proper nutrition. Malnourished and stressed feeder insects are little better than nutritionally-empty filler meals (junk food) for captive animals, and such insects add to the stress of the pets.

In captivity, insects can be lightly ‘dusted’ with a calcium powder supplement prior to being fed to prey animals. It is recommended powdered mineral dust with vitamin D-3 be used to lightly coat insects prior to offering them as food for captive animals once a week. However, despite this recommendation by veterinarians, it is common knowledge in the pet industry feeder insects are often not being dusted with the proper vitamins and minerals captive animals need for good development and health. Insect keepers often overlook dusting commercially available vitamin and mineral powders when feeding insects to their captive animal. Even when insects are properly prepared, it is not particularly effective to dust them with the available commercial dusting supplements because the most common forms use calcium carbonate which is not readily available (bioavailable) for the insect consuming pet. In other words, despite the addition of vitamin D-3, this form of calcium is not well-absorbed by the pet. Other forms of calcium (like calcium chloride) are distasteful to the point where animals will resist consuming it even when used in relatively small dose amounts. Also, insects quickly remove any calcium dust from their exoskeleton through normal grooming and crawling through local bedding material in the vivarium once they have been offered as food.

With the arrival of point-of-sale insects, it is possible to engineer the diet of captive insects to provide them with food from farm-to-retailer to consumer-to-captive animal without the haphazard care crickets and other feeder insects received prior to the innovation. This is important because it has been unreliable to entrust feeding and dusting crickets to novice or busy insect keepers. It is axiomatic well-fed insects are essential for the good health of captive animals. Well-fed insects are often missing from a captive animal's diet. With the development of point-of-sale packages, insects can be fed controlled and engineered diets designed to address certain known dietary deficiencies in zoo animals and certain exotic household pets.

There currently are no cricket (or insect) food pellets which control bacteria, provide extended shelf life and/or address nutritional deficiencies. There have been gel pellets made from a polymer based material (a hydrocolloid such as starch-based “Super-slurper” or polyacrylamide) used in diapers or agar based gels available, but all require adding calcium or other nutrients. Some do claim to provide a nutritional and/or mineral base to gel material but scholarly studies have shown these claims to be deceiving or misleading.

It is desirable 1) to extend the point-of-sale life of insects in containers to at least two weeks, 2) to increase bio-available nutritional qualities of captive insects in point-of-sale containers, 3) to control microbial contamination (e.g., bacterial and fungal buildup) within point-of-sale packages, 4) to reduce the water activity of the supplements within point-of-purchase packages so they retain their appeal to captive insects (water activity is what drives microbial susceptibility) and 5) to create a nutritious food and water combination for insects lasting for at least two weeks so traditional retailers and zoo animal keepers could receive recently developed point-of-purchase insects or more traditional 1,000 count box insects without the daily need of providing either with additional food and water while in their care. This would free store employees, zoo personnel and end users from the tedious and essential task of properly preparing insects for animal consumption.

### SUMMARY OF THE INVENTION

In some embodiments, an insect food supplement may include one or more of the following features: (a) a dry extruded food pellet, (b) a gelled water pellet, and (c) a water barrier on an external surface of the gelled water pellet.

In some embodiments, a dietary supplement may include one or more of the following features: (a) a dry food pellet for providing the nutritional needs for feeder insects, and (b) a wet-gelled pellet having a moisture barrier providing hydration needs for feeder insects.

In some embodiments, a method for processing a wet-gelled pellet for feeder insects may include one or more of the following steps: (a) placing water into a steam kettle, (b) placing ingredients into the steam kettle, (c) heating the water and the ingredients, (d) cooling the water and the ingredients, (e) dispensing the cooled water and ingredients into a portion tray where it cools into a gelled mixture, and (f) applying moisture barrier to the gelled mixture.

In some embodiments, a method for creating a dry food pellet for feeder insects may include one or more of the following steps: (a) inserting ingredients into a batch mixer, (b) pulverizing the ingredients, (c) adding nutrients to the ingredients to create a dry mixture, (d) heating the dry mixture with steam, (e) transferring the heated mixture to an extruder, and (f) heating and pressurizing the mixture in the extruder.

### DESCRIPTION OF THE DRAWINGS

FIG. 1 is perspective view of a cricket habitat/retail package according to an embodiment of the invention;

FIG. 2 is an end view of a cricket habitat/retail package in an embodiment of the present invention;

FIG. 3 shows an elevated front profile of a water/food supplement for insects in an embodiment of the present invention;

FIG. 4 shows a flow diagram of a process to create a water-gel pellet in an embodiment of the present invention;

FIG. 5 shows a gel tray in an embodiment of the present invention; and

FIG. 6 shows a flow diagram of a process to create a food pellet in an embodiment of the present invention.

### DESCRIPTION OF THE PREFERRED EMBODIMENT

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

The inventors' approach is multifaceted and includes efforts to increase the palatability and bioavailability of key nutrients such as calcium, other minerals, vitamins, and antioxidants or free radical scavengers by using alternatives to the conventionally used sources. The inventors' approach also includes efforts to enrich the feeder insects' tissues with nutrients to take advantage of the substantial amount of insect biomass outside of the gut lumen where food is held prior to digestion, absorption and elimination. For example, when most researchers seek to improve calcium content, they use commonly available inorganic calcium compounds such as calcium chloride and calcium carbonate. The inventors have found organic forms such as calcium lactate; calcium propionate, calcium gluconate, and calcium lactate gluconate are much more effective as feeding stimulants than the aforementioned inorganic forms. These organic forms of minerals are known to have higher bioavailability than minerals with inorganic counter-ions in many species of animals. There are further advantages to these compounds such as antimicrobial activity noted in the lactate and propionate forms of calcium.

The inventors wish to 1) improve the basic nutritional quality and vigor of feeder insects, and 2) improve the survival and vigor of feeder insects to be transported for long distances and stored for long periods before being used to feed pets and zoo animals. The inventor's approach and rationale was to find the most nutritional, palatable, bioavailable and stable diet components and to process them into a form retaining the quality of the original materials. The inventors have used the basic principles of insect nutrition, physiology and insect diet technology to determine and optimize the best foods to meet the needs of captive animals relying upon feeder insects.

Embodiments of the present invention provide insects with a dry, carbohydrate-rich diet allowing the insects to use their metabolic pathways to make water (from carbohydrates and lipids) and use their water conservation capabilities to conserve water they make. The protein content is designed to be low enough so a minimum of toxic nitrogenous waste is produced, but high enough so the crickets are not forced to break down their body proteins to meet their day to day metabolic demands while in point-of-sale containers. This embodiment is designed to keep the insects in a steady state wherein they are not stressed in terms of water balance and nutrient equilibrium. This embodiment can minimize the insect frass, exuvia and debris within the point-of-sale habitat to help keep their environment wholesome. In another form of the invention the protein and/or mineral content may be altered to provide a different nutritional makeup from point-of-purchase insects as when more traditional larger quantities of insects are unloaded into holding tanks where the food and water supplement(s) will be consumed by the insects and used to eliminate the daily care insects normally require from their keeper.

Embodiments of the present invention improve captive animal health and provide convenience to those caring for the insects. Embodiments disclose all-natural edible ingredients delivering a healthy protein/carbohydrate balanced diet well suited for both insects and those eating them. It is designed to improve the quality and greatly extend the life and vigor of captive feeder insects.

It is desirable, in terms of palatability, stability, shipping weight, and convenience in handling, to provide a dry diet for crickets in point-of-purchase packages. Currently no point-of-purchase packages can adequately sustain crickets for more than a few days. The conventional “shotgun” diets for crickets contain either a “kitchen sink” approach, have an unnecessarily high protein content within a single pellet, or they were simply gelled or hydrocolloid-bound water and relied on a keepers' intuition or good fortune to find suitable dry foods. While the literature is not clear on the natural diets of Acheta domestics, they are not adapted to feed on fresh plant or animal materials, though they can do so opportunistically. They seem to be more adapted to feed on scraps of various kinds of organic matter (detritus feeding), and it seems they can thrive on a diet largely of stored products, such as dried grains, dried plant materials such as fruits and dried animal materials. They do seem to have a requirement for tocopherol, especially for fertility, which explains their positive response to fish meal and high quality wheat germ.

Embodiments of the present invention disclose a low-water extruded diet and high-water mineral-fortified calcium-enriched gel pellets.

The inventors have developed a feeding system developed to support a high percentage of survival, vigor and nutritional quality for crickets to be transported across country and stored for at least two weeks. Embodiments of the present invention disclose an approach to increasing the nutritional content of feeder animals (e.g., mealworms and crickets) by improving gut loading technology and by improving the nutritional character of the feeder insects' internal organs. Because less than 10% of the insects' weight is found in the gut contents, the inventors propose increasing the nutritional content of the other 90% of biomass could have a great effect on overall nutritional composition of the insects. The inventors also base their efforts at continuous improvement of feeder insects on the hypothesis improvement of diets, microenvironment and shipping conditions will offer a better product to the consumers in zoos and the pet community.

After experimenting with a series of all-in-one diets in gelled formulations of all known cricket (Acheta domesticus L.) nutrients, the inventors changed direction in development by separating the nutrients into a gel to provide water, and a soft, extruded cylinder of a nutritionally complete diet. The inventors made counts of microbes in transport/storage boxes, and found surfaces of the boxes, cricket surfaces and cricket fecal pellets had far lower bacterial counts after two-three weeks where the water and food sources were presented as separate entities. This can be attributed to the lower microbial counts (e.g., aerobic colony forming units) due to the reduction in cannibalism due to greater survival. Also, the separation of nutrients from the gelled water source provides less hospitable media for microbial growth. The gelled material is protected from microbial attack by antimicrobial agents (e.g., calcium propionate, sodium propionate, potassium sorbate and calcium lactate). The gels' pH is lowered with citric acid to stabilize them and further reduce microbial attack and they are gelled with the hydrocolloids carrageenan and locust bean gum. The solid nutrients can be processed by a twin screw extruder, which heat-destroys the substances which are antagonistic to digestion and absorption (e.g., anti-nutrients), and the cooking process makes the food more palatable to crickets.

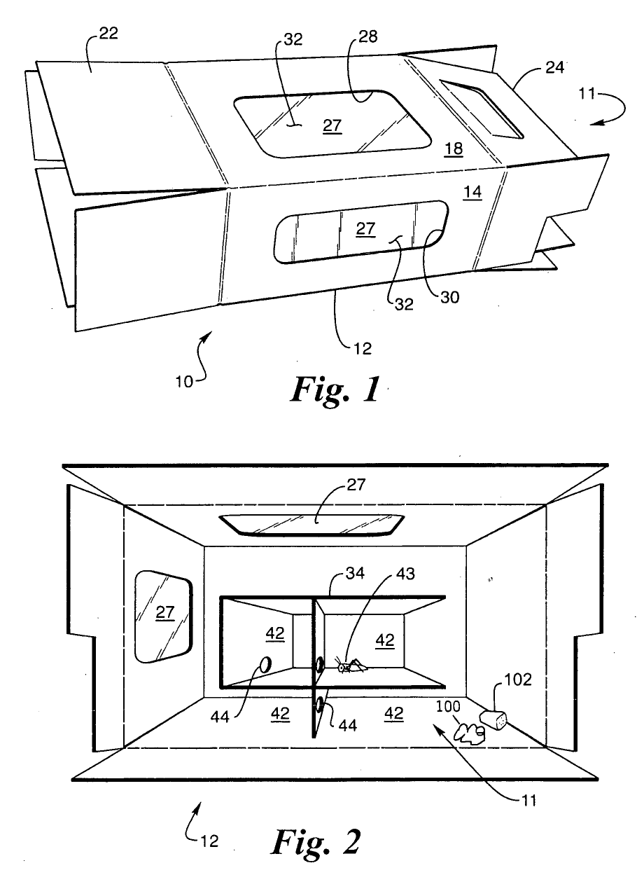

With reference to FIGS. 1 and 2, there is shown an insect habitat and retail package indicated generally at 10. A more formal discussion of an insect habitat and retail package is found in U.S. Pat. No. 7,444,957 issued to Gordon Vadis titled CRICKET HABITAT AND RETAIL RECEPTACLE issued on Nov. 4, 2008 herein incorporated by reference in its entirety. However, for purposes of better understanding embodiments of the present invention a brief discussion of an insect habitat and retail package is given. As described herein habitat 10 houses crickets although habitat 10 could house other species of insect as well without departing from the spirit of the invention. Habitat 10 includes a housing 12. Housing 12 can be formed of most any type of material including plastic or cardboard; however, the inventor has found a moisture absorbent material such as a paperboard material works well. The term paperboard is used comprehensively to include, without limitation, cardboard, fiberboard, and similar products made from cellulose fiber and having a thickness greater than normal paper. Housing 12 can be fabricated of other material fabricated to permit the escape of moisture from the interior of the housing. This could include, for example, a perforated plastic. Housing 12 has an interior space 11 or room for habitation by crickets. Housing 12 has a front wall 14, a back wall 16, a top wall 18 and a bottom wall 20 which define the interior habitat space for insects. The various walls are opaque; however, the walls can be transparent or a combination of opaque or transparent without departing from the spirit of the invention. Housing 12 has end openings closed by end walls 22, 24 formed of end wall panels. End walls 22 and 24 can be glued or constructed to fold together in such a way as to seal package 10. Package 10 can be of varying dimensions such as 1″ to 3″ high, 3″ to 5″ wide and 2″ to 4″ deep. By way of example, the box can typically be 3″×4″×2″ and house 25 to 50 crickets.

Housing 12 has a sight window 27 for viewing crickets. Sight windows 27 can comprise a first cutout opening 28 in top wall 18 and a second cutout opening 30 in the front wall 14. A transparent material 32 can cover the openings. The transparent material can be a continuous clear transparent paper or plastic material covering the cutout openings. Alternatively the covering material can be a tightly woven screen or perforated plastic material. Sight windows 27 admit light and enable viewing of a portion of the interior of housing 12 from the outside. The sight window can by way of example be 2″ to 4″ wide and have a dimension of 1″ to 2″ on the front wall of the housing, and 1½″ to 2½″ on the top wall. In other embodiments discussed above, housing 12 can be transparent thus making housing 12 a window.

In certain environments moisture accumulation in the air inside of housing 12 can be problematic. Crickets do not like to be in a moist environment. The moisture can collect on an impermeable sight window covering material made of transparent plastic. Debris in the housing can adhere to this condensation. When the condensation dries, the debris is stuck to the window covering rendering it unsightly. One way to address this problem is through a window covering formed of a tightly woven mesh. Another way is through the use of a transparent covering material 32 formed of a plastic or plastic-like micro-pore material having micro-perforations of a size suitable to permit the escape of moisture from the interior 11 of housing 12. Such a material can have micro-perforations in the order of magnitude of 70 micron to 300 micron. The micro-perforations serve to let moisture out of housing 12. At the same time condensation of moisture on the inside of the window is avoided.

A cricket habitat environment is provided by a multisided habitat shelter located inside housing 12. The purpose of the habitat shelter is to divide the space inside housing 12 into habitat spaces or compartments connected but separated from one another so as to provide multiple nesting areas for the crickets as well as areas of escape for the crickets from other crickets and from the light. The compartments are divided in such a manner so at least one compartment is shielded from direct light entering through window 27 to provide at least one subdued lighting environment for the crickets.

As shown in FIGS. 1 and 2, housing 12 has a habitat shelter 34. Shelter 34 can fill housing 12 from side-to-side, end-to-end and top-to-bottom. Shelter 34 can be a multi-sided partition of thin walls having flat, curved or convoluted surfaces or combinations thereof.

Housing 12 with shelter 34 provides an ideal environment for crickets. The shelter can be integrally disposed inside housing 12 or can be constructed in such a way with formed holes or cutout openings as to provide access passages such as passage 44 for crickets 43 to move from one surface area to another. Shelter 34 offers a large surface area for crickets 43 to crawl about. Crickets are known to be omnivorous whereby more dominant crickets will eat more vulnerable ones. The various surfaces of habitat shelter 34 and the access passages 44 permit the more vulnerable crickets to escape to other areas. The shelter partitions the interior of housing 12 into a multiple subspaces or separate but connected compartments 42 for the crickets. Some compartments are more shielded than others from light entering window opening 27. The various areas of shelter 34 provide dark areas for live crickets 43 as well as areas of subdued light, both of which are preferred by crickets.

The material of the shelter 34 can be moisture absorbent to absorb condensation which may develop in the package during shipping or otherwise. Shelter 34 adds a measure of rigidity to housing 12 by spanning the volume thereof. This is useful in terms of shipping the item and inventorying and dispensing the item in a store.

Shelter 34 can be manufactured from a nutritious edible material such as a heavy gauge rice paper or wafer paper. As crickets are prone to chew the shelter material, the provision of nutritious material is beneficial to the insects and consequently to animals they feed.

Food and water are provided in the housing 12 as is discussed in more detail below. Crickets with such a food supply can survive for a period of at least seven days, but with the food provided by embodiments of the present invention crickets can survive up to two weeks or even longer. The food supply can be periodically replenished. This prolongs the shelf-life of the product.

Food item 102 provides nourishment in the form of food and moisture. Water can evaporate from an exposed food item which can leave it dry and unappetizing to the cricket as well as depriving the cricket of needed water.

In a first embodiment, a nutrient-rich/high-water-content carrageenan/locust bean gum-gelled diet coated with beeswax is utilized as food item 102. While this embodiment has shown good results in regards to the health of the insect it has also shown it is not as efficient as the embodiments below in controlling bacteria, delivering the nutrients the captive animals need and having extended storage life. A high-water content food item would be a food item having over 75% water by content.

This diet can have high water content. As discussed above, it is a carrageenan/locust bean gum-gelled diet manufactured with grains, vitamins and other essential nutrients to sustain crickets. However, the mixture would need to be coated, enrobed or wrapped with a barrier material to both retard mold and microbial growth and preserve water content. However, a separate water pellet would not be required.

In a second embodiment, a medium-water gelled diet designed for a cooking extruder is disclosed. Medium-water content is defined as being between 10-75%. This embodiment can have the same water content as the pink bollworn diet, which is produced routinely at the USDA (United States Department of Agriculture) APHIS (Animal and Plant Health Inspection Service) Pink Bollworm Facility in their 80 mm cooking extruder in Phoenix, Ariz. This embodiment can have 63% water content and is an agar-based gelled diet. It can be enrobed (as with wax) or wrapped (as with plastic or waxed paper) for shipping cricket pre-packs. However, this embodiment has some of the same limitations as the first embodiment.

An extruder profile used at the Arizona USDA facility to make a 63% water insect diet is shown in Table 1.

TABLE 1

| Element type | Element Size | Zone | Temp profile (F. °) |
|---|---|---|---|
| Feed Screw Screw | 8D | 1 | 150 |
| Forward Paddle | 4 × 60 | 2 | 190 |
| Reversing Paddle | 3 × 60 | 3 | 300 |
| Feed Screw Screw | 2D | 4 | 300 |
| Forward Paddle | 4 × 60 | 5 | 300 |
| Reversing Paddle | 3 × 60 | 6 | 300 |
| Feed Screw Screw | 2D | 7 | 300 |
| Forward Paddle | 4 × 60 | 8 | 265 |
| Reversing Paddle | 3 × 60 | 9 | 240 |
| Feed Screw Screw | 2D | 10 | 205 |
| Forward Paddle | 4 × 60 | 11 | full cool |
| Reversing Paddle | 3 × 60 | 12 | full cool |
| Feed Screw Screw | 2D | 13 | full cool |
| Forward Paddle | 4 × 60 | | |
| Reversing Paddle | 3 × 60 | | |
| Feed Screw Screw | 2D | | |
| Orfice Disk | .25D | | |
| Feed Screw Screw | 2D | | |
| Forward Paddle | 3 × 60 | | |
| Short Pitched Feed Screw | 1D | | |
| Single Lead | 4D | | |
| End Cap | .25D | | |

As discussed, this diet can be a “medium water” diet prepared in an extruder possibly a 80 mm twin-screw extruder. This diet can have a 63% water content and is an agar-based gelled diet. This diet could be coated for shipping crickets in an insect habitat receptacle. As with the diet above, no separate water pellet would be required.

May 28, 2006

| | x-batch | 2x-batch |
|---|---|---|
| Whole wheat flour | 45 | 90 |
| Rice flour | 45 | 90 |
| Brewers yeast | 2 | 4 |
| Vanderzant vitamins | 1 | 2 |
| Sugar | 4 | 8 |
| Corn oil | 3 | 6 |
| Alcolec* | 5 | 10 |
| Water | 100 | 200 |

Bake at 400 F. for 7 min

Cool and enrobe pieces with melted wax, waxed paper, plastic wrap, aluminum foil, etc., to prevent each from drying out

As an alternative to a high or medium water diet, the inventors have discovered an effective low-water diet. A “kangaroo rat” low-water diet intended to be used without coating is disclosed. The expression, “kangaroo rat” diet alludes to the metabolic strategy used by these desert rodents which can survive on diets of less than 5% water content by producing and conserving metabolic water. Terrestrial insects can use the same strategy, as long as the protein content in their diet is not so high removal of excess waste nitrogen (as toxic ammonia or urea) causes life threatening water deficiency. This embodiment has the added advantage of not requiring a water pellet. It has a low water content and low water activity, thus resisting microbial attack and decomposition. Nevertheless, it has high carbohydrate content and a low protein content to support the crickets' use of metabolic water made from the carbohydrates and lipids by the crickets' metabolic processes. A helpful aspect of this embodiment is it can rely on the crickets to supply most of their water requirements using the carbohydrates and some lipids for metabolism. For every molecule of glucose (simple sugar) they metabolize, they can produce 6 molecules of water. Fats (lipids) can be used metabolically to produce water, but they are not generally as easily used for water metabolism, as are carbohydrates. Proteins, on the other hand, can cause water imbalances by inducing an increase in nitrogenous waste products coming from nitrogen excretion accompanying protein metabolism. This embodiment provides a low protein diet containing well-balanced proteins supplying all of the “insect-essential” amino acids.

This embodiment provides a dry diet both for insects in packages or held in keeping tanks reducing or eliminating the need for a separate source of water. House crickets (A. domestica) can thrive at moderate to moderate-high temperatures and less than 50% relative humidity if they are provided with a diet containing 5-10% moisture, high carbohydrates (more than 70%), low protein (less than 10%) and moderate fat (6-8%). Table 2 shows a graphical representation.

TABLE 2

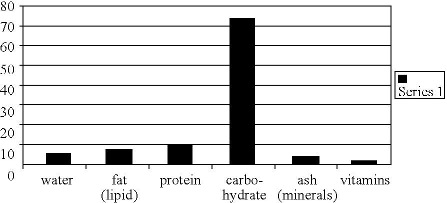

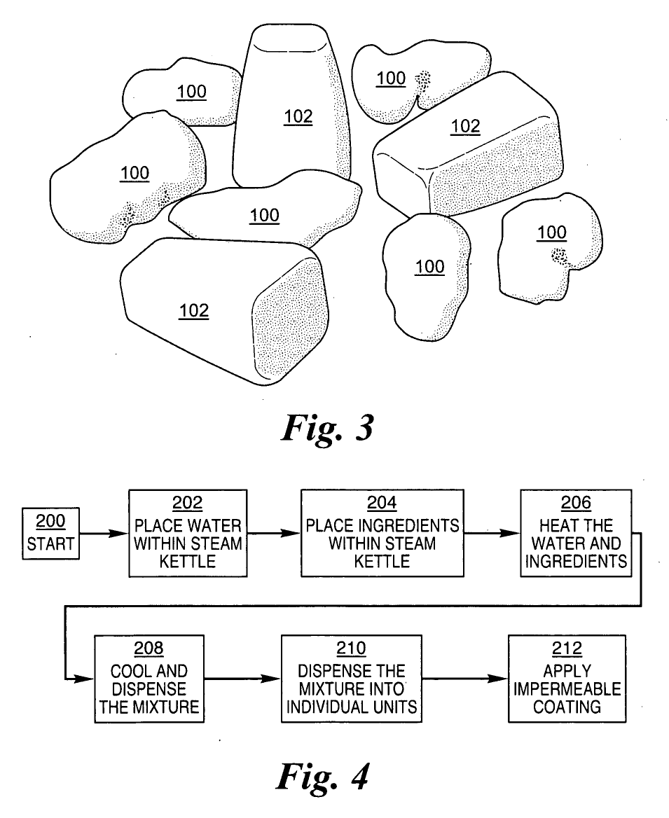

With reference to FIG. 3, an elevated front profile of a water/food supplement for insects in an embodiment of the present invention is shown. An alternative to a high to medium-water content food is discussed below. An alternative embodiment discloses a food item to meet the nutritional needs of zoo animals and certain exotic pets by providing nutritional value within insects sold as food for other animals. The embodiment discloses dry extruded food 100 and gelled water-calcium pellets 102 to better control bacteria for extended use in point-of-purchase packages and traditional keeping containers and allow both types of pellet (extruded food and water gel) to be engineered in terms of palatability and nutritional efficacy (e.g., nutritional value, stability and bioavailability) for key nutrients. The resulting insects become better nutrient delivery systems targeted for a wider range of desirable qualities including minerals like iron, zinc, selenium and various anti-oxidants, pigments, and the calcium/phosphorous balance captive animals often lack—and, more specifically, on a species by species basis.

The use of a cooking extruder can render the diet ingredients 1) free of anti-nutrients which can be toxic to most insects, 2) as a palatable texture, even as a dry material (can also include oil and lecithin helping impart a lasting soft texture in the absence of high water content), 3) well-mixed, 4) free of microbial contaminants, 5) at a low enough water content to preserve the diet during prolonged storage, 6) into a higher state of nutrient bioavailability (compared to non-extruded nutrients), and 7) more flavorful and palatable than ingredients processed by other means.

For bacteria control, paper insect containers keep the atmosphere less humid than the plastic containers. This is important as there is a positive correlation between humidity and microbial growth. Thus, a helpful aspect is to enrobe or wrap a water-gel pellet with a moisture barrier to retard moisture loss and retard microbial growth.

With reference to FIG. 4, a flow diagram of a process to create a water-gel pellet in an embodiment of the present invention is shown. A water-gel pellet can consist of kappa carrageenan (a gelling agent consisting of the extract from red sea cabbage), calcium lactate pentahydrate, locust bean gum and potassium sorbate. The ingredients can be contained within an enrobed, enclosed, or wrapped moisture barrier either a) to be chewed through by insects or b) to provide limited access to the gel through one or more openings. The water gel can contain kappa carrageenan only, but a much higher percentage would be needed to create a satisfactory gel structure, (e.g. greater than 2 percent) or with the inclusion of one, two or all three of the other ingredients to create a useable gel for water hydration within insect pre-packs. The stated ingredient list creates a very well rounded gel structure to carry pigments, calcium/phosphorous, etc., in a way other gels may not be able to reproduce. While it is not necessary to use all or some of the suggested ingredients listed, such as potassium sorbate, calcium lactate or locust bean gum, the inventors have discovered the pellet gels better with the suggested ingredients. Therefore, any combination, including the lack of ingredients, of the suggested ingredients is fully contemplated without departing from the spirit of the invention.

Table 3 shows a listing of ingredients for water gel pellet 102 and their proposed proportions. The inventors have found the mixture of Table 3 to be very good at obtaining a very effective water gel pellet 102.

TABLE 3

| | |
|---|---|
| Water | 100 |
| Calcium propionate | 0.25 |
| Potassium sorbate (MUST NOT be the acid) | 0.5 |
| Calcium lactate (pentahydrate) | 0.25 |
| Citric acid (MUST be the acid form) | 1 |
| Locust bean gum | 0.5 |
| Gelcarin 812 | 0.5 |

A water-gel creation process 200 can begin at state 202, where a steam kettle can be filled with a known quantity of water with a recommended neutral to slightly acid pH base. The concentration of dry ingredients for the water supplement can vary widely but a solution with 0.5% kappa carrageenan, 1.0% calcium lactate pentahydrate, 0.5% potassium sorbate, and 0.5% locust bean gum has been shown to be effective. At state 204 all or some of the ingredients are placed within the steam kettle. The kappa carrageenan is synergistic with locust bean gum and potassium and calcium ions are helpful for effective gelling. The combined interaction significantly improves the rheological properties, including gel strength, gel elasticity, and viscosity characteristics. It also improves the gel's moisture-binding capabilities and creates a resilient gel texture, which resists syneresis (water “bleeding” effect). The dry powders are mixed together and slowly added to cold water within the vortex of a high-speed mixer operating within the kettle at state 204. Heat is applied until the ingredients have dissolved in the water at state 206. Complete solubility typically occurs between 170-175° F. The mixture is allowed to cool to 140° F. and is then pumped or poured into portion trays 150 (FIG. 5) to cool at state 208. One convenient tray to use is the common plastic seed/plug propagation tray purchased before the drain hole has been formed. The trays are then cut on a band saw or with rotary blades or with a hot wire or on a shear press into single cell units 152 and stored for later use at state 210. An impermeable coating can be applied over the opening surface of the tray cells to further retard bacterial growth and/or water activity during storage or while the gels are in use at state 212.

Table 4 shows a representation of one embodiment for a dry food insect supplement successfully produced through a twin screw extruder.

TABLE 4

| | | |
|---|---|---|
| Whole wheat flour | 450 | g |
| Rice flour | 450 | g |
| Brewers yeast | 20 | g |
| Vanderzant vitamins | 10 | g |
| Sugar | 80 | g |
| Corn oil | 100 | g |
| Alcolec* (soy lecithin) | 5 | g |
| Water | 130 | g |

Table 5 shows a representation of another embodiment for a dry food insect supplement successfully produced through a twin screw extruder.

TABLE 5

| | | Pounds per | |
|---|---|---|---|
| | % per ton | ton | |
| Rice | 38.75% | 775 | 2000 |
| Flour | | | |
| Whole Wheat | 39.55% | 791 | 2000 |
| Flour | | | |
| Sugar | 10.00% | 200 | 2000 |
| Corn | 8.50% | 170 | 2000 |
| Oil | | | |
| Brewers Yeast | 1.75% | 35 | 2000 |
| Lecithin | 1.00% | 20 | 2000 |
| Vitamin Mix* | 0.25% | 5 | 2000 |
| Optimun brand Nucleotides | 0.20% | 4 | 2000 |

Table 6 shows a representation of the vitamin mix discussed above in Table 5.

TABLE 6

| | | | | |
|---|---|---|---|---|
| Crude Fiber | Maximum | 0.50% | | |
| Calcium (Ca) Max | Minimum | 0.10% | Maximum | 0.50% |
| Phosphorus (P) | Minimum | 0.10% | | |
| Vitamin E | Minimum | 2,000 | IU/LB | |
| Calcium Pantothenate | Minimum | 500 | MG/LB | |
| Niacin | Minimum | 800 | MG/LB | |
| Riboflavin | Minimum | 200 | MG/LB | |
| Thiamine | Minimum | 200 | MG/LB | |
| Pryidoxine | Minimum | 200 | MG/LB | |
| Folic Acid | Minimum | 50 | MG/LB | |
| Vitamin B12 | Minimum | 1 | MG/LB | |

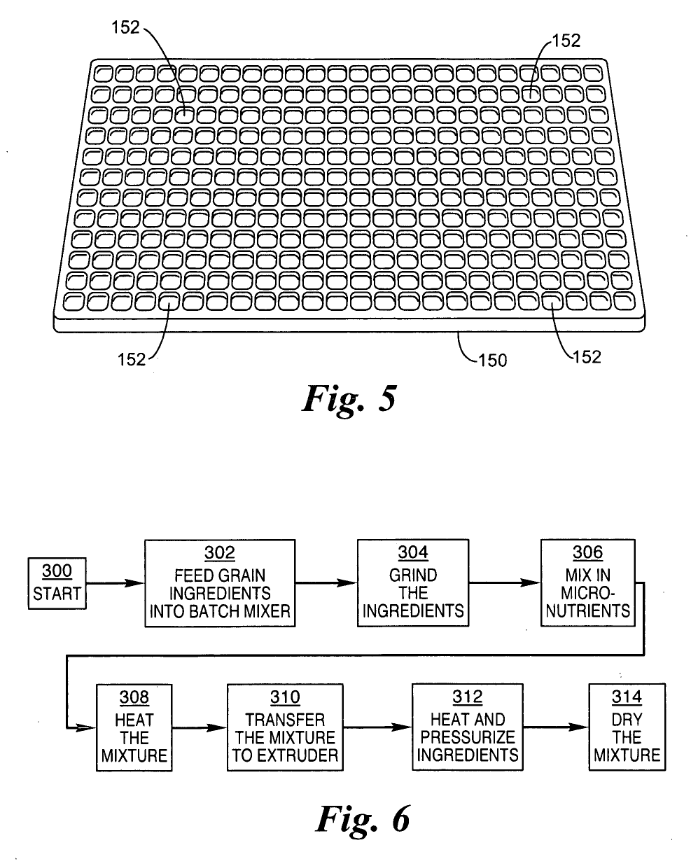

With reference to FIG. 6, a flow diagram of a process to create a food pellet in an embodiment of the present invention is shown. In process 300, grain ingredients (e.g., rice flour, whole wheat flour, sugar, corn oil and brewers yeast) can be thoroughly blended in a batch mixer at state 302. The blended ingredients could then be led into a hammer mill where they are ground until they can fit through an 8 mm screen and become the consistency of flour at state 304. At state 306, micronutrients (e.g., lecithin, nucleotides and vitamin mix) can be blended into the flour-like mixture. The product can then be sent into a mixing pre-conditioner where live steam at a temperature of 240° F. can be injected which will immediately bring the product to 180° F. at state 308. The product can remain at 180° F. wet for 30 seconds. The product can then be transferred to the extruder at state 310. The extruder maintains a temperature of 375° F. for 30 seconds at a pressure of 1400 PSI at 20% moisture at state 312. The product can then be conveyed to a gas fired direct heat fluidized bed dryer for 40 minutes at temperature of 375° F. at state 314.

Once dried food pellets 100 and water-gel pellets 102 can be inserted into retail package 10 which will be later housed with insects. This “low water” diet can be used without a coating since it is provided at such a low water content. It would be resistive to decomposition due to its low water content. Its carbohydrate content would be high enough and its protein low enough it would support the crickets' use of metabolic water made from the carbohydrates and lipids by the crickets' metabolic processes. This diet is “baked” in the extruder to reduce its water content and to denature (or detoxify) anti-nutrients in the wheat germ and flours. Food pellet 100 is assisted by separate water pellet 102.

It is very effective, efficient and inexpensive to produce high quality insect food in cooking extruders and steam kettles. The gel material can be re-heated if it should ever dry out. Dry extruded food pellet 100 has a shelf life many times longer than a moist supplement could withstand.

In a test to determine the effectiveness of the inventor's diet, it was tested against a known diet operating under the brand name of Yummy, which was widely used in the industry during the period when the inventors were testing their invention in terms of individual cricket weights (e.g., which are the single most telling indicator of non-stressed insects) and survival. One of the most threatening factors involved in the degradation of diets is the water activity. The simple rule of thumb is the lower the water activity, the less microbial-based, oxidation-based, and chemically-based degradation can take place. Most microbial activity ceases below 0.75 water activity, and most chemical reactions including oxidation (such as lipid peroxidation and enzymatic reactions cease below 0.50 water activity). Water activity (a_{w}), stated as a decimal such as 0.75 a_{w}, can be expressed as being at equilibrium with 75% relative humidity.

Typically, a_{w} of a gelled diet is about 0.99, which is well-within the range of nearly every microbial contaminant and conducive to various degradation reactions. Therefore the inventors sought to present the nutrients in a form protecting from degradation. Dried, kibbled foods such as cereals and dry pet foods are at low a_{w}, but they are also too hard for many insects to eat or are at reduced palatability. Therefore the inventors sought to formulate a combination of all food requirements for crickets, except water, in a format palatable, nutritious and stable. This led to the dry portion, which is processed by twin-screw extrusion.

The process of twin-screw extrusion involves heating the product to temperatures in excess of 250° F. under high pressure with rapid mechanical action (e.g., mixing, kneading and turning) between a pair of screws. The product is finally expressed from a die forming the food into a desirable shape. In this case, the cricket food is formed into porous cylinders having a crisp, delicate texture easily bitten by even the smallest crickets. The addition of soy lecithin and corn oil help soften the product and keep it easy to bite and chew, even after months of storage. The a_{w} remains under 0.30 even after years of storage at room temperature and typical indoor humidity.

The intention in designing this formulation was to provide a high carbohydrate diet complete in all nutrients known to be required by crickets and related insects. Rice flour is a source rich in palatable arid digestible carbohydrates and proteins, and whole wheat flour is even richer in proteins with a complete amino acid composition.

After 14 days of testing with the first 10 days at a higher stress temperature and the remaining four days in Petri dishes with no food or water, at normal room temperature (68-72° F.), (this very harsh condition was used because it simulated the situation faced by crickets once they run out of food), with 20 g of Yummy in a plastic cup and three pieces of a diet of the present invention with either a 20 g cup of CitriFi suspension in water or 20 g cup of 0.5° Gelcarin gel in water (the Gelcarin suspension includes calcium lactate, locust bean gum, potassium sorbate and either sodium propionate or calcium propionate as preservatives), the diet of embodiments of the present invention gave the crickets a 3-4 fold advantage over the nutrient/water combination in Yummy. The highest survival rate was found in embodiments of the present invention, which included a gel provided with the solid, extruded diet cylinders.

This nutritional profile includes all of the amino acids known to be essential to crickets and related insects. The amino acids include the complete array of “insect essentials”. The lipids include sterols from corn oil, yeast, and whole wheat as well as polyunsaturated fatty acids, essential to many insects, including crickets. The vitamin mixture (Vanderzant vitamins) includes all the vitamins known to be required by crickets and related insects. The rationale behind using brewer's yeast is it contains a complete array of vitamins, minerals, “growth factors” (e.g., undefined components essential to insect growth and development), as well as protein amino acids and valuable lipids. Alcolec (a particulate form of soy lecithin) serves both as a nutritional function and as a texture-providing agent. It is rich in choline, unsaturated fatty acids and some sterols (which are essential to all insects). The lecithin enhances digestion and absorption of lipids, especially sterols, which are of utmost importance to insects. While most of the carbohydrate content of the dry food cylinders (bits) is starch, which can be readily utilized by crickets with their active amylase in their saliva and digestive systems, about 6% of the diet is insoluble fiber, which contributes to stimulation of gut motility. Gut motility is helpful in digestion and absorption of foods.

The gel portion of embodiments of the present invention is primarily a source of water. Because the inventors sought to protect the nutrients from microbial attack, free radical, oxidative, and enzymatic-based deterioration, the inventors designed embodiments of the present invention to take advantage of the crickets' propensity for foraging for their needs. The nutrients can be offered in the solid portion of the diet where they were protected by not being present in an aqueous phase and yet remained highly palatable due to the physical texture and the chemical stimulation provided by the diet ingredients. Biologically, there is a real efficacy to having a palatable (extruded) dry food and a water source to give the crickets a chance to “decide” for themselves when they are hungry (for nutrition) and when they are thirsty. This obeys a concept of nutrient self-selection which says that there is a “biological wisdom” that organisms possess, and given enough choice, they will nurture themselves to the optimal level of health.

The gelled water assists in preventing spilling, drowning small crickets, wetting surfaces (which lead to microbial growth on fecal material) and excessive evaporation of water, which is limited by space and weight constraints. Several gelling agents (known as hydrocolloids), including agar, starch, alginate, gelatin (from animal sources), and carrageenan were experimented with. The inventors also experimented with gel synergists such as locust bean gum, konjac flour, guar gum, and several types of salts.

The inventors have found the palatable and stable gels were typically composed of carrageenan mixed with locust bean gum. Evidently locust bean gum is a feeding stimulant to a number of insects. The salts included calcium, magnesium, sodium and potassium with both inorganic and organic counter-ions. The inorganic counter-ions such as chloride, phosphate, and sulfate were less palatable than the organic counter-ions such as lactate and citrate. The advantage of using calcium salts is any extra calcium the crickets can consume greatly increases their nutritional value in terms of metabolic homeostasis (such as bone and kidney function). The inventors found calcium lactate to be an excellent additive in terms of increasing the palatability of the gel (much more than calcium chloride), as well as boosting calcium content.

One further advantage of calcium lactate is its antimicrobial activity. This was in addition to well-documented antimicrobial agents potassium sorbate and calcium or sodium propionate. These antimicrobial agents were made even more effective by using citric acid to lower the pH of the gels. The inventors found there was a sliding scale of effectiveness against microbial growth and palatability of the gels, the more calcium and lower the pH, the less palatable the gels. Crickets were kept in boxes for more than two weeks at moderately stressful conditions (e.g., about 80° F. or 27° C. and less than 40% RH), and then the remaining crickets were sacrificed and colony forming units (CFU) from cricket body surfaces, fecal materials, and inner surfaces of the box were assessed. The counts of microbes were consistently and considerably higher wherever there was high cricket mortality (stressed insects) and where carcass decay and cannibalism could take place. Therefore, crickets were more healthy and a better food for host animals.

During hot and dry weather, insect food/water source tends to dry up quickly. This will deprive the insects of food/water prematurely, causing them to die prior to point of sale resulting in waste. Typically, the moisture content of the food/water source is high to ensure availability of water to insects. For example, commercially available cricket food can have moisture content as high as 70%. At such a high moisture level, the food is typically wet to the touch and has a water activity close to 1. Such a food/water source will dry up quite quickly during hot and dry conditions. For example, a one cubic inch sample of such food/water source will dry up almost completely to a pea size within 3-4 days if exposed to 88° F. and 25% humidity environment.

One method of prolonging the shelf life of the insect habitat is to incorporate ingredients in the food/water source that can reduce the water activity (moisture vapor pressure) of the food/water source while maintaining the nutritional value and palatability of the food/water source to insects. Typical examples of such vapor-pressure depressing ingredients are glycerol, Calcium Chloride, etc. Calcium Chloride has the added benefit of increasing the Calcium content of the diet which is beneficial to the reptile health.

Another method to extend insect habitat shelf life is to seal off all or a fraction of the food/water source surface with moisture barrier. The moisture barrier can be made of any low moisture permeability materials. The coverage can be done through a variety of processes such as film wrapping, dipping (wax, etc.), filling in moisture barrier cups, or co-extrusion with the food/water ingredient as the interior component and a moisture barrier material as the exterior component. The surface coverage can be done in two different ways:

Seal off a fraction of the food/water source surface, preferably more than 50%, while leave the rest of the food/water source surface exposed for insect access; and

Seal off 100% of the food/water source surface, such that at least a portion of the moisture barrier can be penetrated by the insects for access to food/water. For crickets, an example of such insect penetrable moisture barrier is bees wax.

The partial coverage can be accomplished in many different processes. For example, in co-extrusion with food/water source inside and moisture barrier on the outside (or extruding the food/water material into a moisture barrier tube), a rotating knife can chop off the extrudate to form cylindrical-shaped insect food with the middle surface sealed and the two ends exposed. The moisture barrier in this case can be plastics such as polyethylene (PE), or any film forming materials with low moisture permeability. The insect food and the barrier material need to be formulated or chosen such that the two materials have adequate adhesion to each other. This is to reduce the likelihood of slippage, and more importantly, separation under drying stress when the food is partially exposed during storage or as it is being consumed by insects. The partial coverage can also be done by wrapping a cube of the insect food with a moisture barrier film while leaving one or two ends of the cube exposed. It can also be done via a dipping process where part of the insect food is covered while being dipped into a film-forming, moisture barrier liquid. An example of which is wax. After dipping and drying, the covered portion of the surface is released and open while dipped surface is covered by a moisture-barrier film. The partial coverage can also be done by filling slurries of insect food/water mixture into a cup made of or lined with moisture barrier materials. The food/water source made this way would have all surface covered with a moisture barrier except of the open top. The mixture may gel upon cooling to give it body and consistency.

A full coverage of moisture barrier over the surface of insect food/water source has the added benefit of minimized moisture loss as drying is completed inhibited until insects start to penetrate and open up areas for access. Even then, the exposed area tends to be small and drying slow.

One method to accomplish full moisture barrier coverage is to dip the whole food/water source piece into a film-forming moisture barrier liquid such as wax. Film thickness can be adjusted by liquid temperature, dip duration time and removal rate. The required film thickness is a function of the moisture barrier material. For wax and plastic films such as PE, a thickness of ˜1 mil can be adequate.

Another method is to fill a cup made of or lined with moisture barrier material with insect food/water slurry and then seal off the top with an insect penetrable moisture barrier material such as bees wax.

For simplicity, it is also possible to design the insect food/water source and insert into one integrated unit. For example, an insert made of moisture barrier material can be designed with exterior surface area and partition space along with an interior chamber which can hold insect food/water source. The insect food is exposed on one or both ends but is covered in the middle to reduce drying. A co-extrusion process can be used to make such an insert, with the moisture barrier insert material (such as PE) on the exterior and the insect food/water ingredient slurry in the interior.

Thus, embodiments of the COMBINATION WATER AND FOOD INSECT SUPPLEMENT are disclosed. One skilled in the art will appreciate the present teachings can be practiced with embodiments other than those disclosed. The disclosed embodiments are presented for purposes of illustration and not limitation.

What is claimed is:

1. An insect food supplement, comprising:
a dry extruded food pellet; and
a gelled water pellet.

2. The insect food supplement of claim 1, wherein the food pellet contains the nutritional needs of insects sold as food for other animals.

3. The insect food supplement of claim 2, wherein the food pellet is substantially free of anti-nutrients.

4. The insect food supplement of claim 3, wherein the food pellet contains lecithin to provide a palatable texture.

5. The insect food supplement of claim 3, wherein the food pellet is free of microbial contaminants.

6. The insect food supplement of claim 3, wherein the food pellet has a low water content below 8% to preserve the food pellet during prolonged storage.

7. The insect food supplement of claim 3, further comprising a water barrier on an external surface of the gelled water pellet.

8. A dietary supplement, comprising:
a dry food pellet for providing the nutritional needs for feeder insects; and
a wet-gelled pellet having a moisture barrier providing hydration needs for feeder insects.

9. The dietary supplement of claim 8, wherein the dry food pellet can contain any one rice flour, whole wheat flour, wheat germ, sugar, corn oil or brewers yeast.

10. The dietary supplement of claim 8, wherein the wet-gel led pellet can contain any one of water, kappa carrageenan, calcium lactate pentahydrate, potassium sorbate or locust bean gum.

11. The supplement of claim 9, wherein the dry food pellet is processed in an extruder.

12. The supplement of claim 9, wherein the dry food pellet contains 8% moisture or less.

13. The supplement of claim 10, wherein the wet-gelled pellet is resistive to mold and microbial growth.

14. The supplement of claim 10, wherein the dry food pellet can contain lecithin to create a palatable texture.

15. A method for processing a wet-gel led pellet for feeder insects comprising the steps of:
placing water into a steam kettle;
placing ingredients into the steam kettle;
heating the water and the ingredients; and
cooling the water and the ingredients.

16. The method of claim 15, further comprising the step of dispensing the cooled water and ingredients into a portion tray where it cools into a gelled mixture.

17. The method of claim 16, further comprising the step of applying moisture barrier to the gelled mixture.

18. A method for creating a dry food pellet for feeder insects, comprising the steps of:
inserting ingredients into a batch mixer;
pulverizing the ingredients;
adding nutrients to the ingredients to create a dry mixture; and
heating the dry mixture with steam.

19. The method of claim 18, further comprising the step of transferring the heated mixture to an extruder.

20. The method of claim 16, further comprising the step of heating and pressurizing the mixture in the extruder.
